(19) United States
(12) Patent Application Publication
(10) Pub. No.: US 2015/0250154 A1
(43) Pub. Date: Sep. 10, 2015

(54) SQUID-SHAPED SOFT LURE FOR FISHING

(71) Applicant: Kabushiki Kaisha HOPEC, Ise-shi (JP)

(72) Inventor: Yukio HAMAGUCHI, Ise-shi (JP)

(73) Assignee: Kabushiki Kaisha HOPEC

(21) Appl. No.: 14/448,293

(22) Filed: Jul. 31, 2014

(30) Foreign Application Priority Data
Mar. 10, 2014 (JP) 2014-45913

(51) Int. Cl. A01K 85/02; A01K 85/16

(52) U.S. Cl. CPC A01K 85/02; A01K 85/16

(57) ABSTRACT

A squid-shaped soft lure simulating color tone, shimmer and movement of a live squid is formed as a squid-shaped lure main body made of a transparent or translucent thermoplastic elastomer with rubber-like elasticity into which shimmering substances are incorporated. The lure has a hollow interior to receive along its length a line which is to be equipped with a hook. A plurality of colored rings, each of which is a segment of a transparent or translucent soft synthetic resin hose having an outer circumferential face covered by a hologram sheet adhered thereto and one eyeball retaining ring which is a segment of the same or a like hose and onto a surface of which a pair of symmetrical eyeball sheets are adhered are integrally press-fitted into respectively the trunk part of the lure main body and the head part thereof in such a manner that the rings are communicatively connected in a concentric fashion and serially arranged as a whole.

### BACKGROUND OF THE INVENTION

The present invention relates to a squid (cuttlefish) shaped soft lure (artificial bait) which is used appropriately in trolling and long-line fishing mainly for large-size migrant fish and also relates to an effective manufacturing method thereof.

Japanese Published Unexamined Patent Application No. 2009-278953 and Japanese Utility Model Registration No. 3102359 have disclosed a squid-shaped lure used in long-line fishing and trolling mainly for tuna. Further, Japanese Published Examined Patent Application No. S-57-30453 and Japanese Published Examined Patent Application No. S-58-39495 have disclosed a method for manufacturing a squid-shaped lure from a transparent soft synthetic resin, in particular, sol paste of polyvinyl chloride resin by means of dip (immersion) molding.

In general, in order to stimulate the bait searching instinct of fish to be caught, not only an external shape of a lure (artificial bait) but also movement, shimmer (luster) and color tone (coloring, pattern) thereof are required to closely resemble those of live bait (real bait). As described above, Japanese Published Unexamined Patent Application No. 2009-278953 has disclosed artificial bait which is formed in a squid shape by using a synthetic resin and coloring just like a live squid is given to an outer circumferential face thereof. However, in that the artificial bait is expected to obtain fish gathering effects of tuna (fish to be caught) by using the smell of live bait released from a smell impregnated member (10) installed inside a hollow part (1a), it is inferior in stability and reliability of the effects.

Although the smell of the live bait is continuously released from the smell impregnated member (10) made with an elastic material, the smell inevitably disappears sooner or later. Further, it is quite troublesome to make available sea water (31) having a strong smell of live bait and also difficult to obtain fish gathering effects which will justify time and labor thereof.

Further, Japanese Utility Model Registration No. 3102353 has disclosed a squid-shaped lure and the lure is provided with a trunk part (12a) which is formed with a tube body made of a flexible silicon-based resin. Although aluminum foil for reflecting light is bonded on an entire surface including a wind cone-shaped part (12b) thereof, a head main body (111) is a solid article formed, with a transparent synthetic resin in a square rod shape, the surface of the head main body is not only covered with light reflection pieces (112), (113) composed of natural shells, horn pieces of a red bull or glass but also covered with a transparent protection cover (14). Thus, the squid-shaped lure is unable to mimic the movement of a live squid or realize color tone (coloring/pattern) of the body surface of the squid and also gives a sense of discomfort to tuna (fish to be caught) when biting the lure. As a result, it is quite clear that the squid-shaped lure is inferior in fish gathering effects thereof.

Further, Japanese Published Examined Patent Application No. S-57-30453 and Japanese Published Examined Patent Application No. S-58-39495 have disclosed a method for manufacturing squid-shaped artificial bait in which polyvinyl chloride paste is used. Therefore, although the artificial bait is transparent, it is inferior in terms of transparency and appearance of freshness when soaked into water, thereby giving an impression which is what is called an opaque dead squid.

Still further, the above described artificial bait is devoid of elasticity and strechability that rubber has and, in particular, a wind cone-like leg part of the bait is torn off at an early stage. Thus, the bait is unable to keep an external appearance of a live squid and also unable to exhibit shimmer (luster) or movement, resulting in a failure of providing fish gathering effects of fish to be caught.

### SUMMARY OF THE INVENTION

The present invention has been made in order to provide a fundamental solution to the above described problems, an object of which is to provide a squid-shaped soft lure or an integrated product manufactured by such procedures that a plurality of colored rings, each of which is a circular segment of a soft synthetic resin round hose and a hologram sheet adhered to a circumferential face of the hose segment orthogonal to the axis of the hose segment, are integrally press-fitted into a trunk part inside a lure main body integrally formed in a hollow squid shape which is made of shimmering substances incorporated transparent or translucent thermoplastic elastomer in such a manner that the rings are communicatively connected in a concentric fashion and arranged serially. Thereby, the squid-shaped soft lure is extremely excellent in transparency and freshness, and in combination with reflection of light which has passed through the lure main body, hologram of the hologram sheet and the shimmering substances, the lure main body gives to fish to be caught strong impressions of color tone (coloring/pattern) and shimmer (luster) which closely resemble those of the body surface of a live squid (real squid), thereby improving fish gathering effects of the fish to be caught.

Further, the thermoplastic elastomer which is high not only in transparency as described above but also high in elasticity and strechability that rubber has is adopted as a material of the lure main body. And, the plurality of colored rings, each of which has a hologram sheet pasted to an outer circumferential face of the soft synthetic resin hose, and one eyeball retaining ring in which a pair of symmetrical eyeball sheets are pasted to an outer circumferential face of the transparent or translucent soft synthetic resin hose are integrally press-fitted into the hollow interior of the lure main body in such a manner that the rings are communicatively connected in a concentric fashion and arranged serially as a whole. Thereby, there is provided a squid-shaped soft lure which is able to bend and deform freely at 360 degrees in all directions. This lure is able to give realistic impressions of swimming movement of a live squid (real squid) to fish to be caught, offering excellent fishing results achieved by professional fishermen.

In this case, although the thermoplastic elastomer of the lure main body is flexible, the colored rings and the eyeball retaining ring, each of which is cut into a segment, with a round cross section from the soft synthetic resin hose which is relatively harder than the elastomer, are integrally press-fitted into the hollow interior in what is called a reinforced core pipe. As a result, while the squid-shaped soft lure is able to freely bend and deform as described above, there is no fear that the lure main body gets out of shape or is torn apart.

Further, an object as a method for manufacturing the squid-shaped soft lure of the present invention is such that the lure main body is integrally formed in a hollow squid shape with a transparent or translucent thermoplastic elastomer having rubber-like elasticity into which shimmering substances are incorporated, and a plurality of colored rings, each of which is composed of the soft synthetic resin hose which is divided so as to give a round cross section and the hologram sheet which is wound in an integrated manner around an outer circumferential face of the hose and one eyeball retaining ring which is composed of the transparent or translucent soft synthetic resin hose and a pair of symmetrical eyeball sheets pasted to an outer circumferential face of the hose are inserted and fitted outside one common round-rod jig so that the rings are arranged serially, and in the above described state, these rings are operated and press-fitted into the hollow interior from a leg part of the lure main body, and a restorative shrinkage force resulting from expansion and deformation of the lure main body at the time of the above operation is used to firmly attach each and all of the colored rings and the eyeball retaining ring to the hollow interior and thereafter, only the round rod jig is pulled out from the lure main body, thus making it possible to easily manufacture (assemble) a soft lure which closely resembles a live squid (real squid) in terms of the color tone (coloring/pattern), shimmer (luster) and swimming movement without using a special adhesive agent.

It is noted that other objects and effects will be self evident from a detailed description of preferred embodiments of the present invention which will be described later.

### BRIEF DESCRIPTION OF THE DRAWINGS

FIG. 1 is a perspective view which shows a soft lure of the present invention.

FIG. 2 is a side view of FIG. 1.

FIG. 3 is a cross sectional view taken along the line 3-3 in FIG. 2.

FIG. 4 is a cross sectional view of a hologram sheet for the colored ring.

FIG. 5 is a plan view of an eyeball sheet.

FIG. 6 is an enlarged cross sectional view taken along the line 6-6 in FIG. 5.

FIG. 7 is a cross sectional view which shows an injection mold for molding a lure main body.

FIG. 8 is a cross sectional view taken along the line 8-8 in FIG. 7.

FIG. 9 is a cross sectional view taken along the line 9-9 in FIG. 7.

FIG. 10 is a cross sectional view which shows the molded lure main body.

FIG. 11 is a cross sectional view taken along the line 11-11 in FIG. 10.

FIG. 12 is a cross sectional view taken along the line 12-12 in FIG. 10.

FIG. 13 is a perspective view which shows dimensional and positional relationships between a round rod jig and a soft synthetic resin hose.

FIGS. 14 (a) -(f) are side views which show steps of manufacturing a colored ring and an eyeball retaining ring.

FIG. 15 is a perspective view which shows a completed ring of FIG. 14(f) installed.

FIG. 16 is a perspective view which shows the colored rings and the eyeball retaining ring in FIG. 15 disassembled from one another.

FIG. 17 is a cross sectional view which shows a process in which the colored rings and the eyeball retaining ring are fitted outside the round rod jig and this jig is press-fitted into the lure main body.

FIG. 18 is a cross sectional view which shows a state that the jig has been completely press-fitted into the lure main body subsequent to FIG. 17.

FIG. 19 is a perspective view corresponding to FIG. 15 which shows a modified embodiment.

FIG. 20 is a perspective view which shows the soft lure into which a line tied with a hook is inserted and wired.

FIG. 21 is a plan view of FIG. 20.

FIG. 22 is a side view of FIG. 21.

FIG. 23 is a cross sectional view taken along the line 23-23 in FIG. 21.

FIG. 24 is a cross sectional view taken along the line 24-24 in FIG. 22.

FIG. 25 is a plan view which shows a state that the soft lure is bent.

FIG. 26 is an overall schematic side view which explains trolling for tuna with use of the soft lure.

FIG. 27 is an enlarged view of portion P1 of FIG. 26.

FIG. 28 is an enlarged perspective view of a resistance board of FIG. 26.

FIG. 29 is an enlarged view of portion P2 of FIG. 26.

FIG. 30 is an enlarged view showing in detail a boat rod supporting part on a vessel body as in FIG. 26.

FIG. 31 is an overall schematic side view corresponding to FIG. 26 and which explains special trolling.

FIG. 32 is an enlarged view of portion P3 of FIG. 31.

FIG. 33 is an overall schematic perspective view corresponding to FIG. 26 which explains another particular form of trolling.

### DETAILED DESCRIPTION OF THE INVENTION

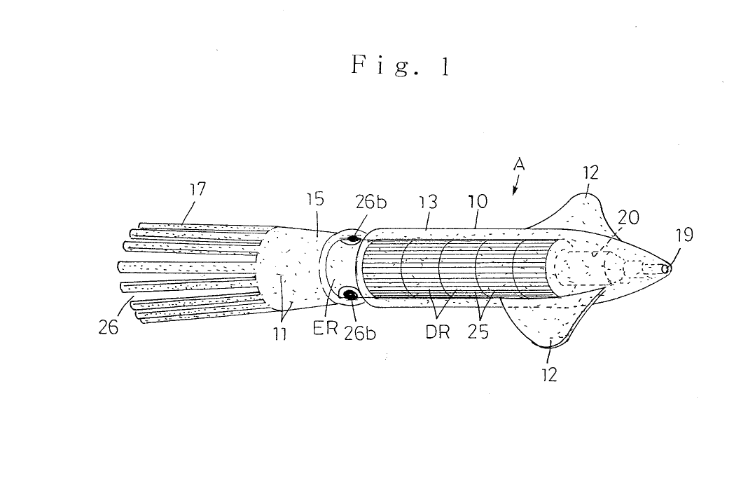

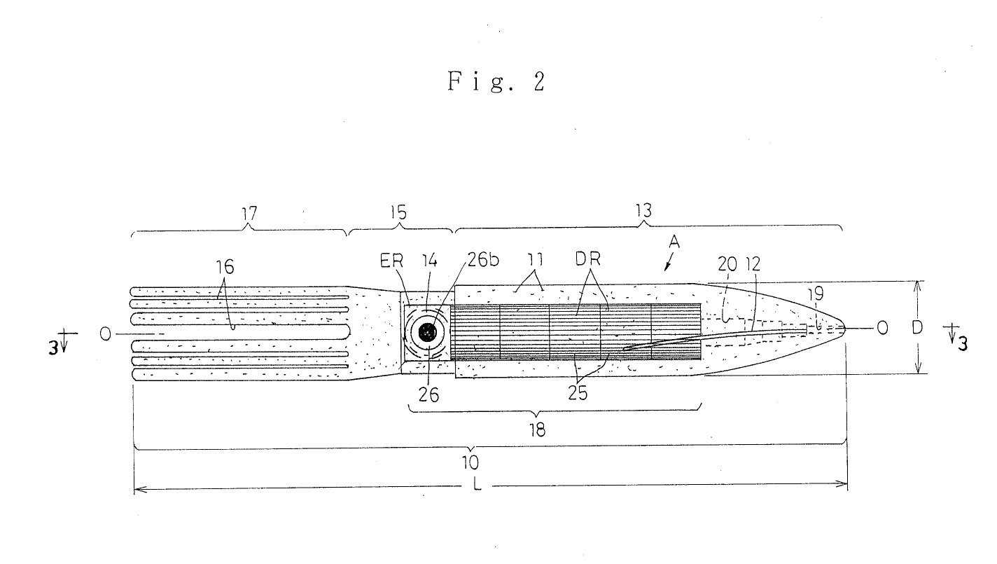

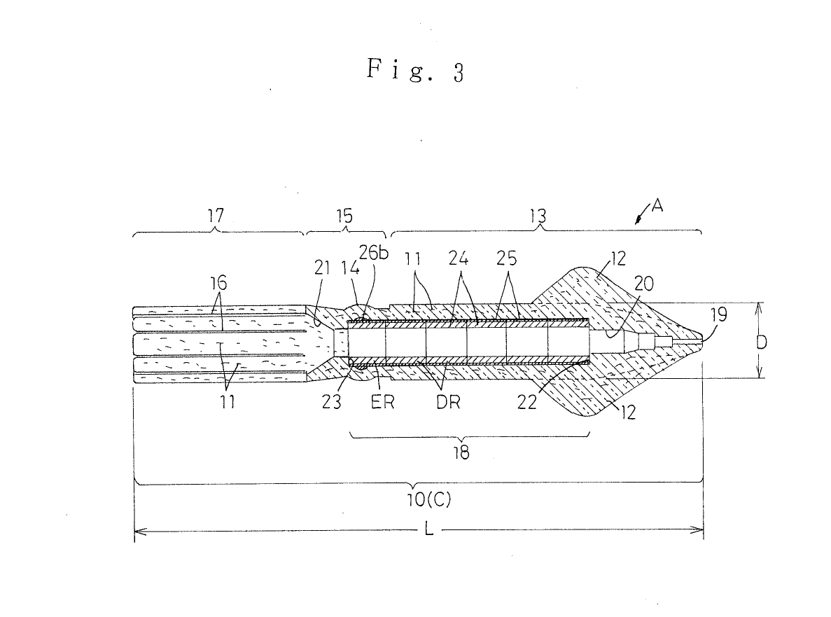

Hereinafter, drawings will be used to give a detailed description of preferred embodiments of the present invention mainly with reference to typical squid-sized dimensions as one example. In FIG. 1 to FIG. 3 which shows the squid-shaped soft lure for fishing (A), a reference numeral (10) indicates a hollow lure main body having a fixed overall length (L) (about 150 mm) and thickness (diameter) (D) (about 20 mm), and the lure body is injection-molded into a rough configuration shape of a squid (cuttlefish) acting as live bait for fish to be caught by using a transparent thermoplastic elastomer (TPE) having rubber-like elasticity into which shimmering substances (photo-luminescent fine fragments) (11) are incorporated.

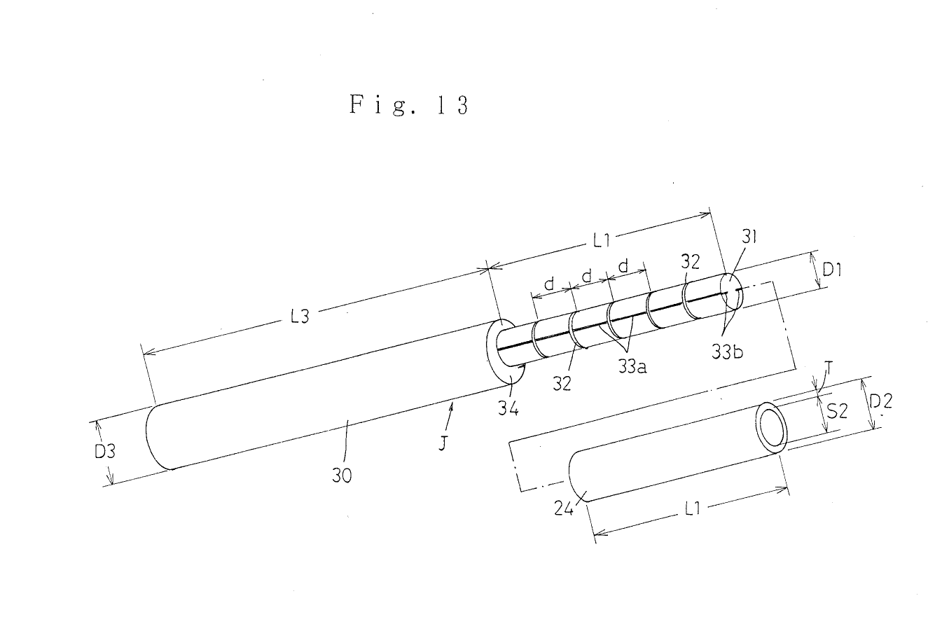

That is, the squid-shaped soft lure for fishing is formed continuously in an integrated manner from a bullet-shaped trunk part (13) from which a pair of symmetrical fins (12) project, and, contiguous with the trunk part (13) a head part (15) having a symmetrically arranged pair of eyeball covering convex faces (14) of circular-arc cross-section, to a wind-cone like leg part (17) having many parallel slits (16) (10 slits are shown in this figure). And, a void space (C) extending lengthwise and symmetrically with respect to a longitudinal center line (O-O) of the lure main body (10) is fully open (unobstructed) at the leg part (17) (See FIG. 10).

The void space (C) of the lure main body (10) includes a ring receiving tubular hole (18) concentric with the void space (C) as a whole and having a predetermined length (L1) (about 60 mm) and an inner diameter (S1) (about 13 mm) and which extends from a position on the length of the lure substantially corresponding to the lengthwise position of a middle point of the base of fins (12) to a position corresponding to a middle of the head part (15), a line receiving tubular hole (20) formed in a step-wise tapering shape from the front end of the ring receiving hole (18) to a position of a narrow line insertion hole (19) at the pointed leading end of the trunk part (13) and a jig receiving guide hole (21) formed in a trumpet shape (conical shape) gradually expanding outward from the rear end of the ring receiving hole (18) to the base (proximal end) of the leg part (17). (See FIGS. 1-3.)

Next, a border step part between the ring receiving hole (18) and the line receiving hole (20) functions as a stopper (22) for receiving the colored ring to be described later, and a border step between the ring receiving hole (18) and the jig receiving guide hole (21) functions as a stopper (23) for receiving the eyeball retaining ring to be described later. A fixed length (L2) from the stopper (23) for receiving the eyeball retaining ring to a freely-moving leading end of the wind cone-like leg part (17) is slightly shorter than the length (L1) of the ring receiving hole (18), that is, L2 is about 55 mm. (See FIG. 10.)

The thermoplastic elastomer (TPE) which is used as a material of the lure main body (10) includes various types of elastomers such as olefin-based, styrene-based, acryl-based, polyester-based, urethane-based and polyvinyl chloride-based elastomers. In particular preferable are those excellent in transparency, strechability and resistance to weather (for example, styrene-based thermoplastic elastomer and acryl-based thermoplastic elastomer).

Further, the above described shimmering substances (photo-luminescent fine fragments) (11) are incorporated with the transparent thermoplastic elastomer in just appropriate amounts and in an interspersed manner so as to give realistic impressions of color spots and patchy patterns on the body surface of a live squid. Not only shimmering gold-color and silver-color but also various types of other colors may be imparted.

Still further, it is acceptable that the lure main body (10) is not only transparent in itself but also translucent like “frosted glass,” if the interior thereof can be seen through from outside when used on exposure to water (in a state that the lure is immersed into water).

In order to prevent adhesion between adjacent lure main bodies (10) and adhesion to other objects when they are packaged many times, transported, stored or not in use, powder (not illustrated) may be sprayed on the surface (outer face) of the lure main body (10). As a matter of course, the powder for preventing adhesion will be washed away when the lure is immersed in water and the lure main body (10) will become transparent.

A reference symbol (DR) indicates a plurality of colored rings (a total of five rings in the drawings) which are integrally press-fitted, into the ring receiving hole (18) of the lure main body (10) in such a manner that the rings are communicatively connected in a concentric fashion and serially arranged. Each of the colored rings DR is composed of a transparent or translucent soft synthetic resin hose (24) (preferably, a nylon hose or a vinyl hose) cut into a segment with a round cross section and a hologram sheet (25) adhered to and covering the surface (outer circumferential face) of the hose. In combination with light reflecting actions of hologram on the hologram sheet (25), passage of color through the lure main body (10) and the shimmering substances (photo-luminescent fine fragments) (11) of the lure main body (10), impressions of vivid shimmer and movement of a live squid are given to provide excellent fish gathering effects of fish to be caught.

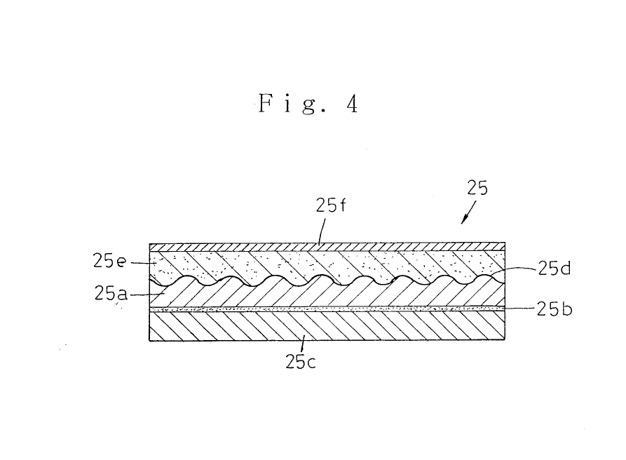

As shown in a cross sectional view of FIG. 4, the hologram sheet (25) is a layered body which is composed of a thermoplastic resin sheet (25a) of polyethylene or polypropylene as a transfer seal (tacking paper), a mold releasing sheet (25c) adhered to the back thereof via a pressure-sensitive adhesive agent layer (25b), a reflection layer (25e) in which metal powder such as aluminum or silver is melted or metal foil is vapor-deposited on a hologram forming layer (relief face) (25d) on the front side of the thermoplastic resin sheet (25a), and a colored layer (25f), the surface of which is color-painted or color-printed to reflect metal luster of the reflection layer (25e). The mold releasing sheet (25c) is peeled therefrom and the hologram sheet (25) is integrally wound around the surface (outer circumferential face) of the soft synthetic resin hose (24).

In this case, any color may be given to the above described colored layer (25f). However, it is preferable to use the same type of color as that used in shimmering substances (photo-luminescent fine fragments) (11) to be incorporated in a material of the lure main body (10) (for example, a “warm” color is used for both or a “cold” color for both).

A reference symbol (ER) indicates an eyeball retaining ring which is also composed of a transparent or translucent soft synthetic resin hose cut into a segment with a round cross section (24) (preferably the same as that of the colored ring (DR)) and a pair of symmetrical circular eyeball disc-shaped sheets (26) adhered to the surface (outer circumferential face) of the hose. The soft synthetic resin hose (24) of the eyeball retaining ring (ER) is integrally press-fitted into the rear end of the ring receiving hole (18) of the lure main body (10) so as to be communicatively connected in a concentric fashion to the soft synthetic resin hoses (24) of the colored rings (DR) and serially arranged. While these rings are thus attached by being press-fitted in an integrated manner, the pair of symmetrical eyeball discs (26) on the eyeball retaining ring (ER) are positioned so as to correspond to the eyeball covering faces (14) of the lure main body (10).

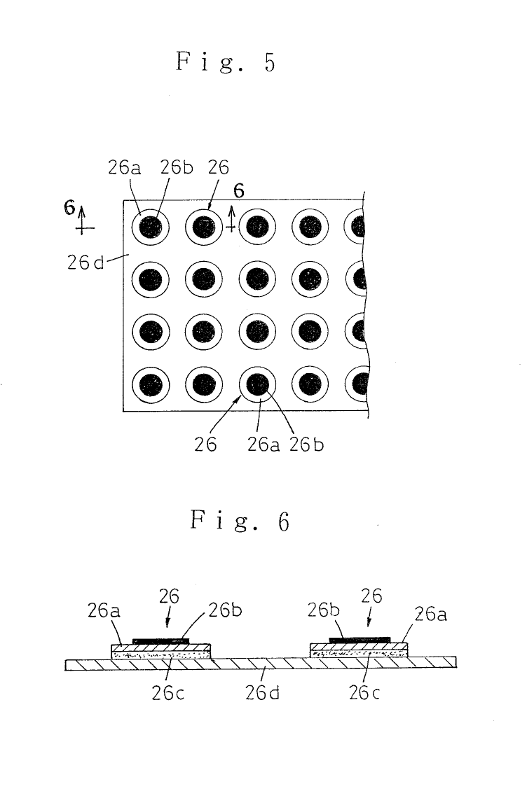

As shown in FIG. 5 and FIG. 6, each of the eyeball discs (26) is composed of a disc-shaped soft reflection sheet (26a) to which, hologram processing or metal vapor deposition is given as a transfer seal (tacking paper), an eyeball (26b) which is imparted by being color-painted or color-printed to the surface thereof, and, on the underside of each soft reflection sheet (26a), an adhesive agent layer (26c), and a mold releasing disc (26d) adhered to the back of the soft reflection discs (26a) via the pressure-sensitive adhesive agent layer (26c). The mold releasing disc (26d) is peeled from the eyeball disc (26), and the pair of symmetrical soft reflection discs (26a) to which the eyeballs (26b) are imparted are integrally adhered to the surface (outer circumferential face) of a soft synthetic resin hose (24) from which segments are to be severed to serve as the eye rings ER.

It is acceptable that the eyeball (26b) is imparted to the surface of the soft reflection sheet (26a) so as to rise three-dimensionally in a conical shape. It is also acceptable that an alternative conical cover (not illustrated) made of a transparent resin is used to mask the eyeball (26b) which is formed flat.

The following method can be employed to manufacture the above arranged squid-shaped soft lure (A).

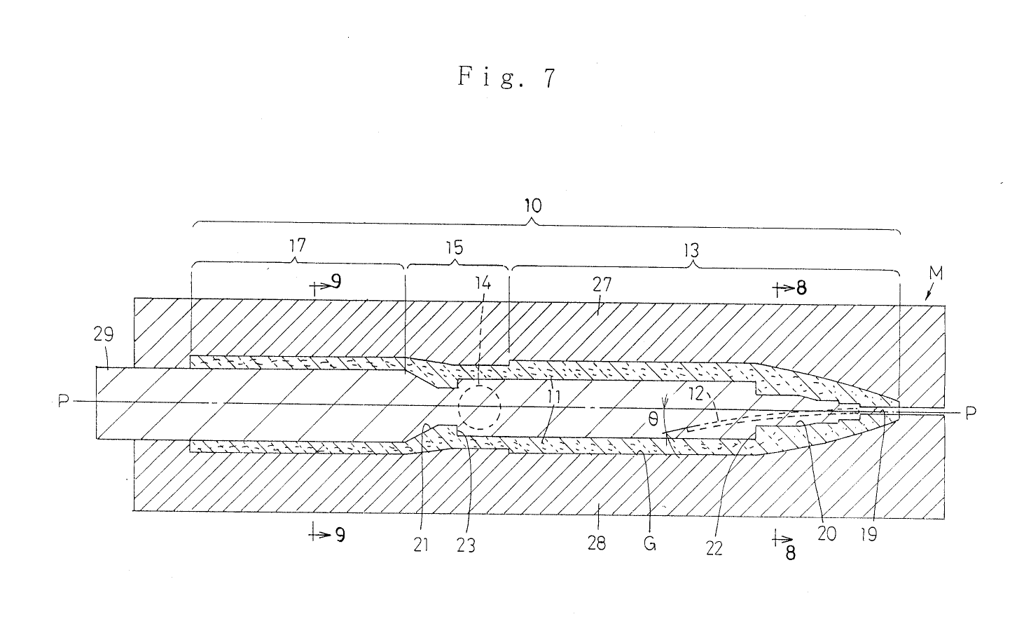

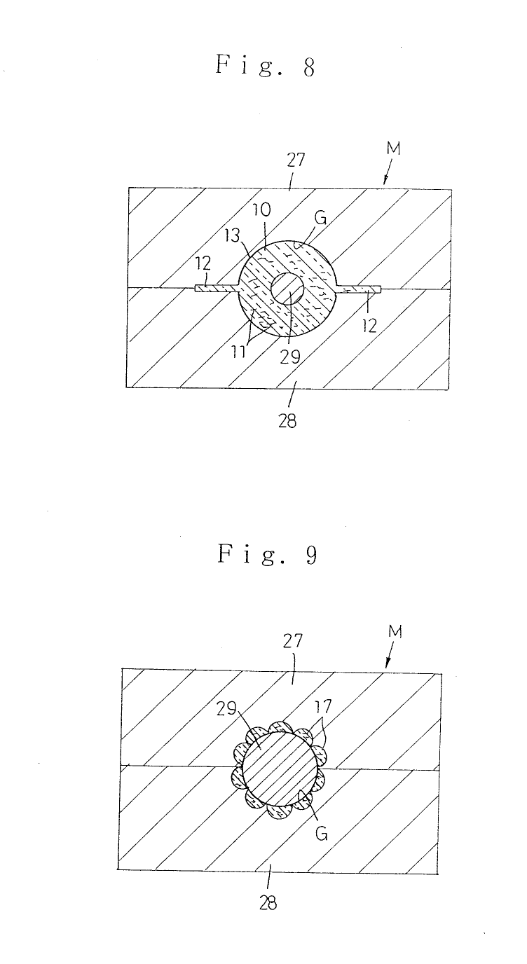

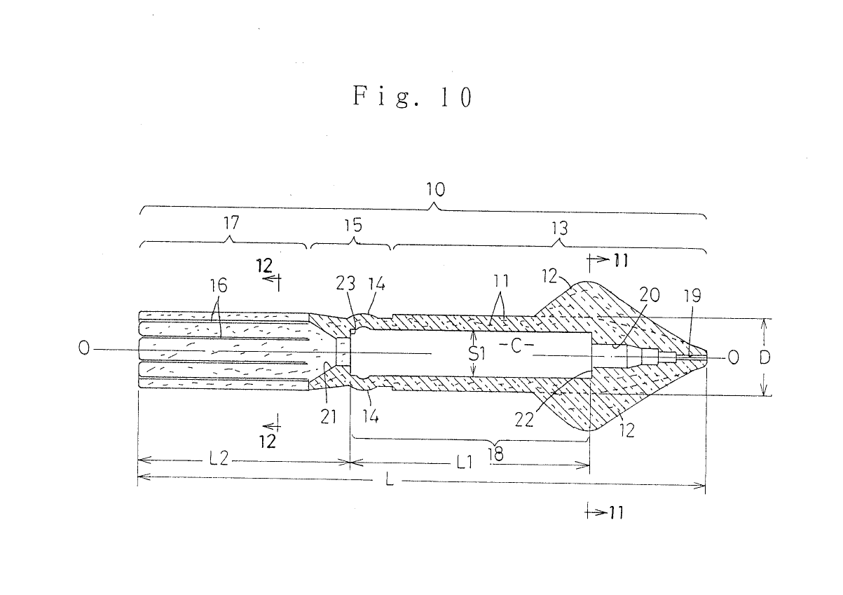

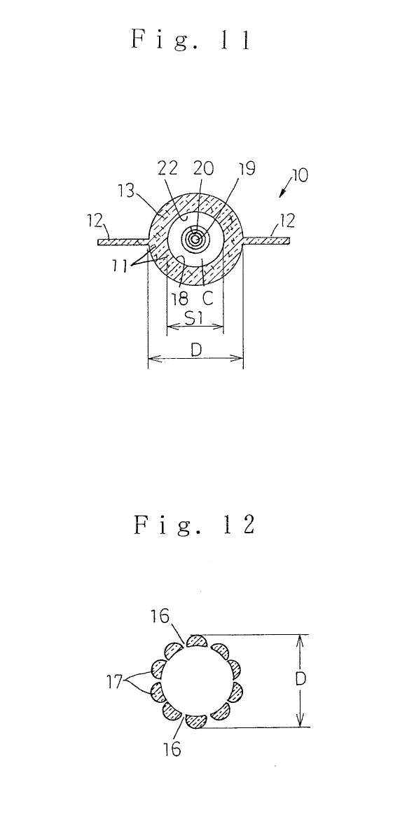

That is to say, as shown in FIG. 7 to FIG. 9, the transparent or translucent styrene-based or acryl-based thermoplastic elastomer (a material in molten state) into which the shimmering substances (photo-luminescent fine fragments) (11) are incorporated is injected into a cavity (G) partitioned by an upper mold (27), a lower mold (28) and a core (29) of an injection mold (M). And, the elastomer is thus molded and solidified to manufacture the hollow lure main body (10) as shown in FIG. 10 to FIG. 12.

In this case, the mold (M) may be assembled, while the pair of symmetrical fins (12) which expand from the trunk part (13) of the lure main body (10) are positioned so as to correspond to a parting line (P-P) between the upper mold (27) and the lower mold (28). Even where the fins (12) do not accurately correspond to or align with the parting line (P-P) and are slightly inclined by a certain angle (θ) or there are some irregularities on the surface (outer circumferential face) of the lure main body (10) and on the back face of the void space (C), the lure main body (10) is made of a material high in rubber-like elasticity and strechability. Thus, the lure main body (10) can be easily released from the injection mold (M).

Individual constituents which constitute the lure main body (10) and the void space (C) are given the same reference numerals as those of FIG. 1 to FIG. 3. And, the same reference numerals are indicated in FIG. 7 to FIG. 12, with a detailed description omitted.

On the other hand, apart from molding of the lure main body (10), there are manufactured and made available the plurality of colored rings (DR) (a total of five rings in the drawings) and one eyeball retaining ring (ER) which are integrally press-fitted, into the void space (C) of the lure main body (10).

A reference symbol (J) is a round rod jig which is used for an intended purpose and made of an ABS resin, polypropylene or other hard synthetic resins. As shown in FIG. 13, the jig is provided with a thick shaft part (30) at a proximal end section of the jig which can be used as a grip and a thin shaft part (31) at a distal end section thereof to receive the soft synthetic resin hose (24) beginning with the leading end thereof and which acts as an insertion core. The jig is designed to be rotated by a machine tool (not illustrated) which chucks a base portion of the distal end. of thick shaft part (30) in a detachable manner.

In this case, the thin shaft part (31) of the round rod jig (J) is provided with a length (L1) (about 60 mm as shown previously) which is equal to the length (L1) of the ring receiving hole (18) on the lure main body (10) and an outer diameter (D1) (about 12 mm) which is equal to the inner diameter (S1) (about 13 mm as shown previously) of the ring receiving hole (18) or slightly smaller than the inner diameter (S1) thereof.

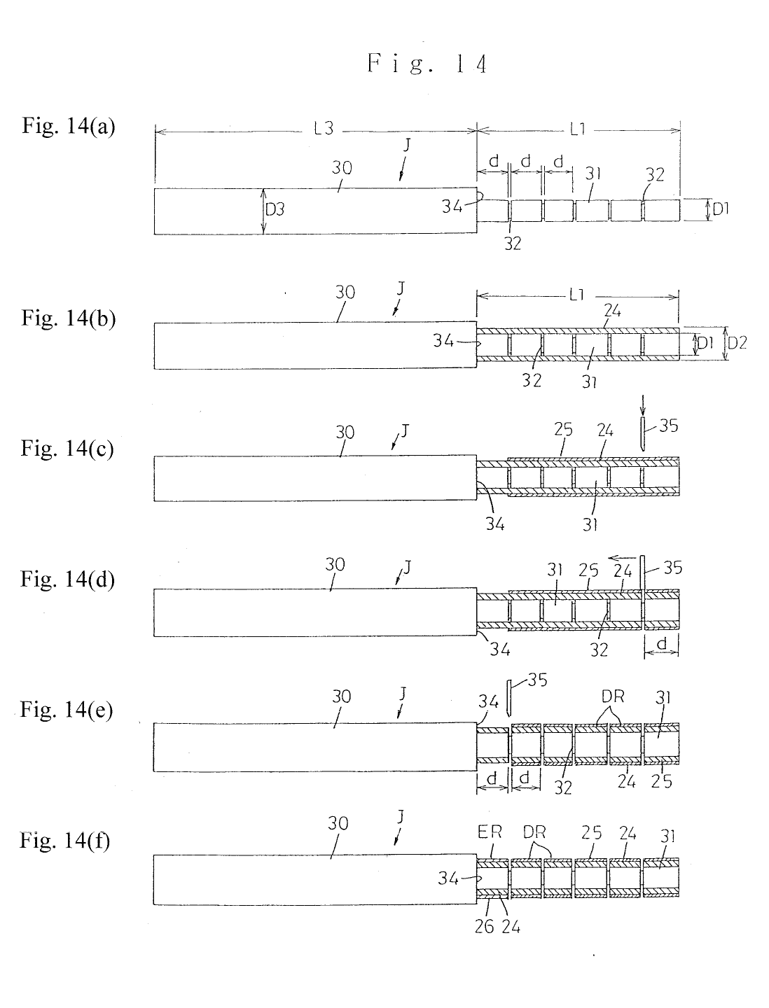

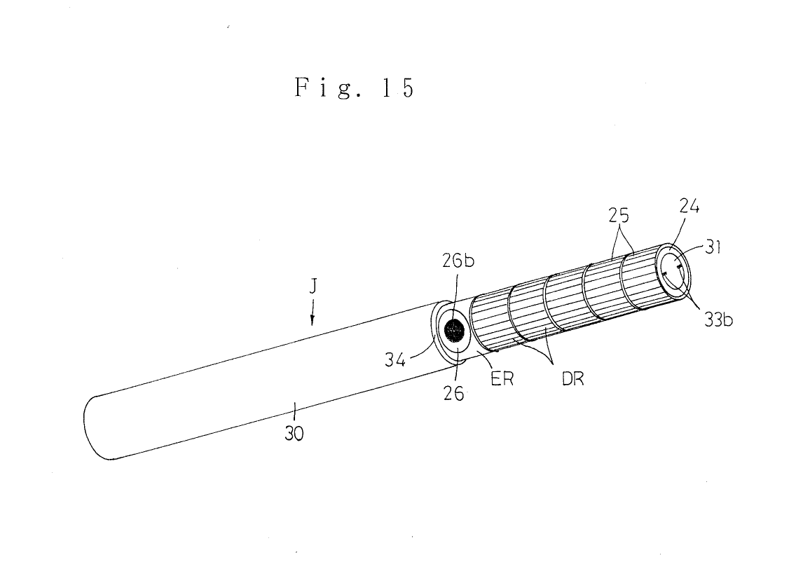

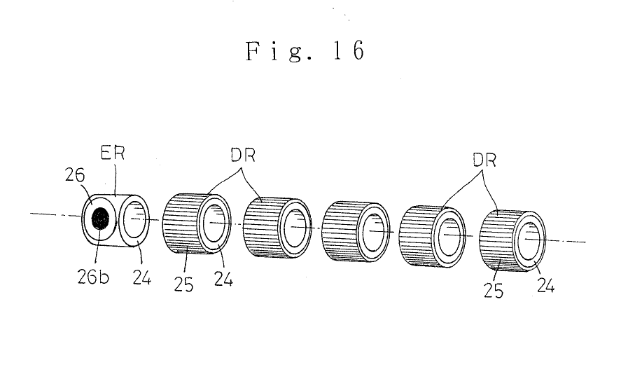

Further, as shown in FIG. 13 and FIG. 14, a plurality of recessed peripheral grooves for guidance (32) (a total of five grooves in the drawings) of arcuate cross section are formed on the surface (outer circumferential face) of the thin shaft part (31) preferably arrayed in parallel, at uniform and fixed intervals (d) (about 10 mm). Also, on the surface (outer circumferential face) and/or on the flat leading end face of the thin shaft part (31), there are provided a pair of symmetrical eyeball positioning guide marks (33a), (33b) preferably aligned straight.

The recessed peripheral groove for guidance (32) cut so as to give an arcuate cross section is formed of such a depth that substantially corresponds to a total value of the thickness (T) (about 1.5 mm) of the soft synthetic resin hose (24) and the thickness of the hologram sheet (25) wound around the surface (outer circumferential face) of the hose. Cutter edges are inserted into the grooves, thereby reliably dividing and cutting the soft synthetic resin hose into segments with a round cross section.

The soft synthetic resin hose (24) is harder than the thermoplastic elastomer which is a material of the lure main body (10), the inner diameter (S2) of which is (about 12 mm) substantially equal to the outer diameter (D1) of the thin shaft part (31) of the round rod jig (J), and the outer diameter (D2) of the soft synthetic resin hose (24) is set to be about 15 mm which is slightly larger than the inner diameter (S1) of the ring receiving hole (18) of the lure main body (10). Therefore, the soft synthetic resin hose (24) is fits in a detachable manner on the thin shaft part (31) of the round rod jig (J), and the soft synthetic resin hose (24) on the thin shaft part (31) is to be forcibly pressed (press-fitted) into the ring receiving hole (18) of the lure main body (10) which will be described later.

The thick shaft part (30) of the round rod jig (J) is formed so as to be larger in outer diameter (D3) (about 16 mm) than the thin shaft part (31) and longer in length (L3) (about 100 mm) than the length (L2) (about 55 mm) from the rear end (the stopper for receiving the eyeball retaining ring) of the ring receiving hole (13) on lure main body (10) to the freely moving leading end of the leg part (17). With the thick shaft part (30) being gripped, the thin shaft part (31) can be easily inserted into the ring receiving hole (18) of the void space (C) of the lure main body (10) from the leg part (17) at which the void space (C) is fully open. A reference numeral (34) indicates a border step between the thin shaft part (31) and the thick shaft part (30) and is to receive a leading end face of the soft synthetic resin hose (24) when inserted into the hose (20).

Therefore, as apparent from FIG. 13 and FIGS. 14 (a), 14 (b), the transparent or translucent soft synthetic resin hose (24) which is in advance cut so as to be equal in fixed length (L1) (about 60 mm) to the thin shaft part (31) of the above described round rod jig (J) is received, in a detachable manner, on the thin shaft part (31) of the round rod jig (J) starting with the leading end of the hose (24). Thereafter, as shown in FIG. 14 (c), the hologram sheet (25) is integrally wound around the surface (outer circumferential face) of the soft synthetic resin hose (24).

In this case, the hologram sheet (25) is available as a transfer seal (tacking paper). It is, thus, acceptable that the hologram sheet (25) is adhered so as to cover the surface (outer circumferential face) of the soft synthetic resin hose (24) via the pressure-sensitive adhesive agent layer (25b) which is exposed by peeling off the mold releasing sheet (25c).

However, regarding the soft synthetic resin hose (24) which is mounted on the thin shaft part (31) of the round rod jig (J) from the leading end of the hose (24), as shown in FIG. 14(c), the hologram sheet (25) is not to be wound only on a part of the hose (24) corresponding to the length of a fixed interval (d) (about 10 mm as shown previously) immediately adjacent the step part (34) bordering on the thick shaft part (30), that part being left for adhering the eyeball discs (26) thereto.

The hologram sheets (25) are each a rectangle, of about 47.5 mm in width, and about 50 mm in length for winding once around the soft, synthetic resin hose (24). Since the soft synthetic resin hose (24) is transparent or translucent, the recessed peripheral grooves (32) can be seen through the soft synthetic resin hose (24).

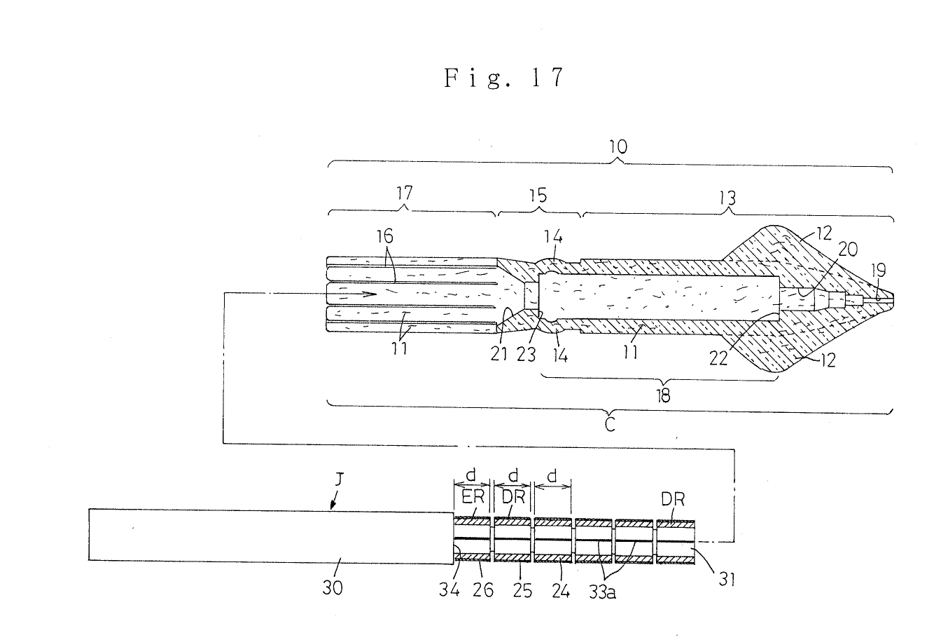

Next, the base of the round rod jig (J) is chucked on a machine tool (not illustrated) and rotated by using the machine tool. Also, as shown in FIG. 14(c), FIG. 14(d), FIG. 14(e), the edge of the cutter (35) is sequentially inserted through the soft synthetic resin hose (24) and into each peripheral groove for guidance from the groove positioned adjacent the leading end of the jig to the groove positioned adjacent the base of the thin shaft part of the jig. Thereby, the soft synthetic resin hose (24) on which the hologram has been wound is divided and cut into a plurality of segments with a round cross section, as shown in FIG. 14(e) and FIG. 15.

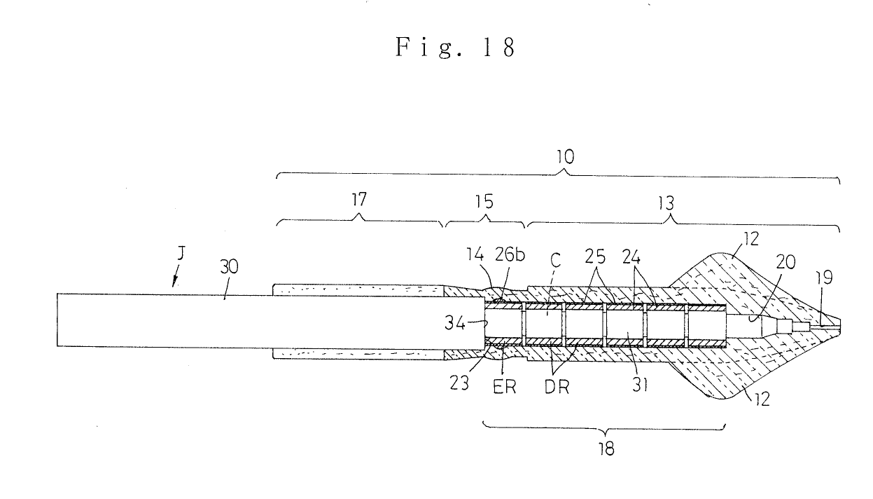

Therefore, there are manufactured the plurality of colored rings (DR), each of which is a segment with a round cross section (a total of five rings in the drawings). However, at the border step part (34) of the round rod jig (J), there remains only one soft synthetic resin hose (24) which is a segment with a round cross section around which no hologram sheet (25) is wound. As shown in FIG. 14(f), FIG. 15 and FIG. 16, the pair of symmetrical eyeball sheets (26) are adhered to the soft synthetic resin hose (24) of the remaining segment, thereby also manufacturing one eyeball retaining ring (ER).

In this case, it is acceptable that both of the eyeball sheets (26) are adhered to the surface (outer circumferential face) of the soft synthetic resin hose (24). With guidance provided by the pair of symmetrical eyeball positioning guide marks (33a), (33b) on the thin shaft part (31) of the round rod jig (J) which can be seen through the soft synthetic resin hose (24), the pair of symmetrical eyeball sheets (26) are accurately positioned so as to be in alignment with the guide marks (33a), (33b).

It is, however, possible that the eyeball sheets (26) be adhered to the surface (outer circumferential face) of the soft synthetic resin hose (24) in a process before the hose is divided and cut into segments.

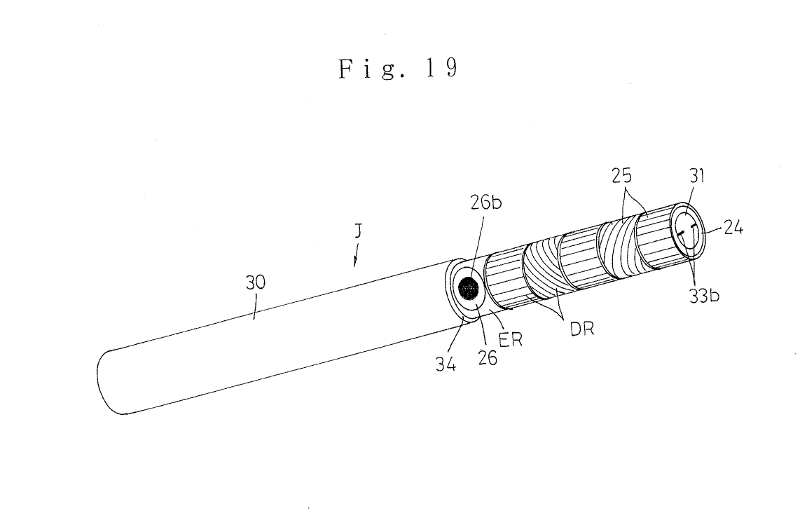

Next, as described above, when the plurality (a total of five) of colored rings (DR) and one eyeball retaining ring (ER) have been manufactured and made available, the round rod jig (J) acting as a core is removed from the machine tool (not illustrated) while the colored rings (DR) and the eyeball retaining ring (ER) remain mounted on the round rod jig (J) as shown in FIG. 15 and FIG. 17. While the thick shaft part (30) is gripped, the rings, still mounted on the thin shaft part (31) of the jig (J), are press fitted, by axial thrusting of the jig, into the ring receiving hole (18) on the hollow lure main body (10) from the leg part (17) which is fully open, as shown in FIG. 17 and FIG. 18.

A restorative shrinkage force resulting from expansion and deformation of the inner diameter (S1) is used, by which the plurality (a total of five) of colored rings (DR) are internally placed at the trunk part (13) of the lure main body (10) and one eyeball retaining ring (ER) is internally placed at the head part (15) of the lure main body (10) in a firmly attached state. These rings are not integrally fixed with use of a special adhesive agent.

In this case, the eyeballs (26b) of the eyeball sheet (26) are positioned and adjusted so that they correctly correspond to and align with the pair of symmetrical eyeball covering faces (14) rising from the head part (15) of the lure main body (10) as shown in FIG. 18. Thereby, the lure is to have an external appearance of a live squid which attracts fish to be caught.

Further, where the thin shaft part (31) of the round rod jig (J) is operated for the press fitting of the rings into the ring receiving hole (18) in the void, space (C) of the lure main body (10), it is preferable that the lure main body (10) is in advance soaked in water, thereby allowing the back face thereof (inner circumferential face) to absorb water. This is helpful in carrying out the operation of press-fitting easily and smoothly.

The jig receiving guide hole (21) formed at the head part (15) of the lure main body (10) is of a trumpet shape (conical shape) the diameter of which increases toward the leg part (17). This is also helpful in carrying out the above press-fitting operation easily and smoothly.

In any case, the colored rings (DR) are integrally press-fitted into the trunk part (13) of the ring receiving hole (18) of the lure main body (10) and one eyeball retaining ring (ER) is integrally press-fitted into the head part (15) thereof in such a manner that these rings are communicatively connected in a concentric fashion and serially arranged as a whole, as shown in FIG. 18. Thereafter, the thin shaft part (31) of the round rod jig (J) is pulled out from the lure main body (10), by which a product, the squid-shaped soft lure (A) can be obtained as shown in FIG. 1 to FIG. 3.

In the method for manufacturing the colored rings (DR) and the eyeball retaining ring (ER) described with reference to FIG. 14 (a) to 14(f), the soft synthetic resin hose (24) with the fixed length (L1) is mounted on the thin shaft part (31) of the round rod jig (J), the hologram sheet (25) is wound around the surface (outer circumferential face) of the hose and, thereafter, while the round rod jig (J) is rotated, the cutter (35) is used to cut the colored rings (DR) and the eyeball retaining ring (ER) so as to produce segments with a round cross section. According to the above described method, it is possible to manufacture efficiently the plurality of colored rings (DR) and one eyeball retaining ring (ER). Further, as apparent from FIG. 17 and FIG. 18, these rings can be press-fitted into the ring receiving hole (18) of the hollow lure main body (10) with the rings continuously shifting together in the configuration shown in FIG. 14(f) or FIG. 15 with that configuration kept as it is. Thus, it is safe in saying that this is an extremely effective manufacturing method (assembly method).

However, as long as the above described method is a manufacturing method (assembly method) in which the colored rings (DR) and the eyeball retaining ring (ER) are manufactured and, in particular, mounted on the thin shaft part (31) of the round rod jig (J) and, with this state kept, these rings are press-fitted into the ring receiving hole (18) of the hollow lure main body (10) by using the round rod jig (J), it is acceptable that the cutting of the colored rings (DR) and the eyeball retaining ring (ER) so as to produce segments with a round cross section be carried out at any time and by any method.

That is, it is acceptable that, for example, the colored rings (DR) and the eyeball retaining ring (ER) be manufactured by another appropriate method without using the round rod jig (J) and, thereafter, these rings be mounted on the round rod jig (J) as shown in FIG. 15 and integrally press-fitted into the ring receiving hole (18) of the hollow lure main body (10) as shown in FIG. 17 and FIG. 18.

In this case, as indicated by a modified embodiment of FIG. 19 corresponding to FIG. 15, it is acceptable that the plurality of colored rings (DR) are alternately different in color provided on the colored layer (25f) on the hologram sheet (25) and the rings are mounted, on the thin shaft part (31) of the round rod jig (J) so as to give what is called a streak pattern. In the streak pattern in which colors are alternately different, fish to be caught are able to more easily recognize the movement of the squid-shaped soft lure (A), which is effective.

Further, as described previously, the plurality of colored rings (DR) and one eyeball retaining ring (ER) are formed with a common one transparent or translucent soft synthetic resin hose (24). It is acceptable that the soft synthetic resin hose (24) which constitutes the plurality of colored rings (DR) is not necessarily transparent or translucent. This is because the surface (outer circumferential face) thereof is to be covered by the hologram sheet (25).

Still further, a description has been given of the recessed peripheral grooves (32) at uniform and fixed intervals. It is also acceptable that the intervals are made non-uniform and that the plurality of colored rings (DR) are accordingly changed in width of each segment. This is because in this case as well, the hollow lure main body (10) of the soft lure (A) is able to bend and deform throughout the 360 degrees of its circumference, i.e., in all directions.

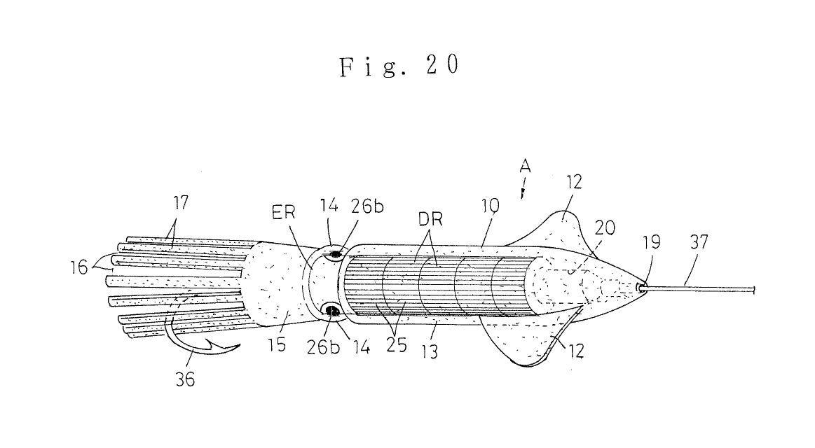

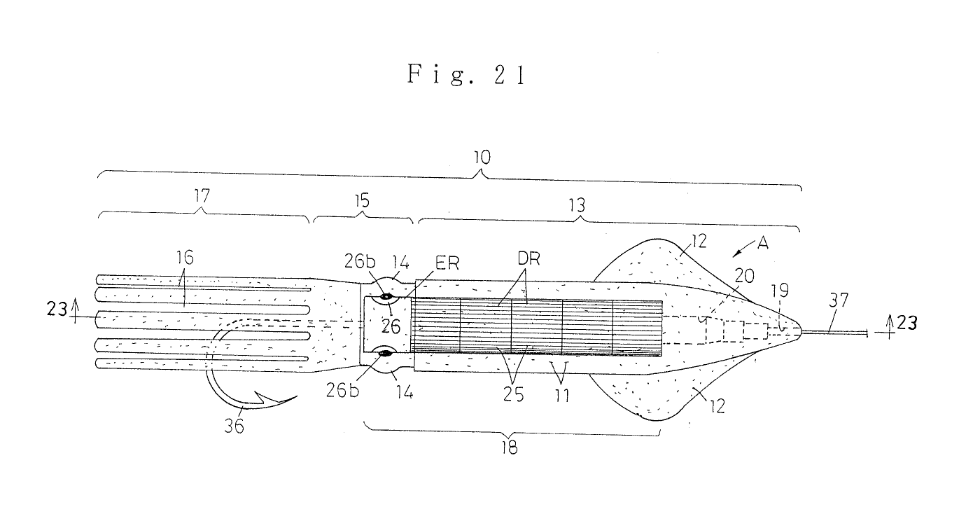

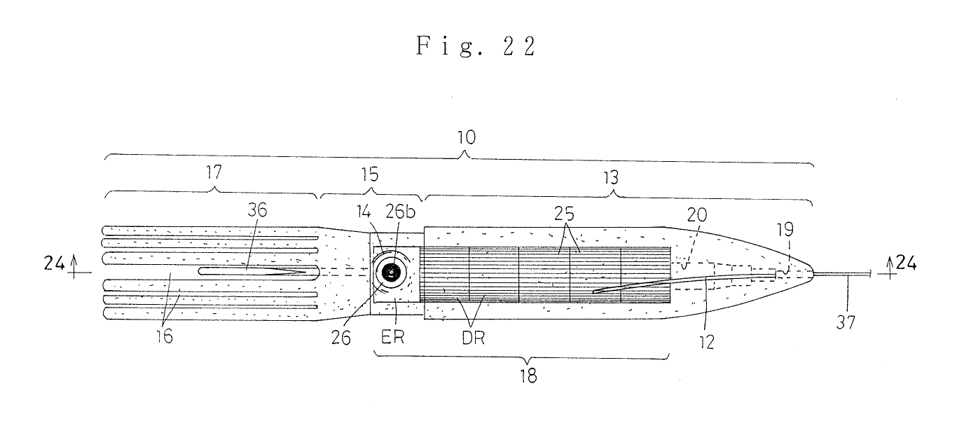

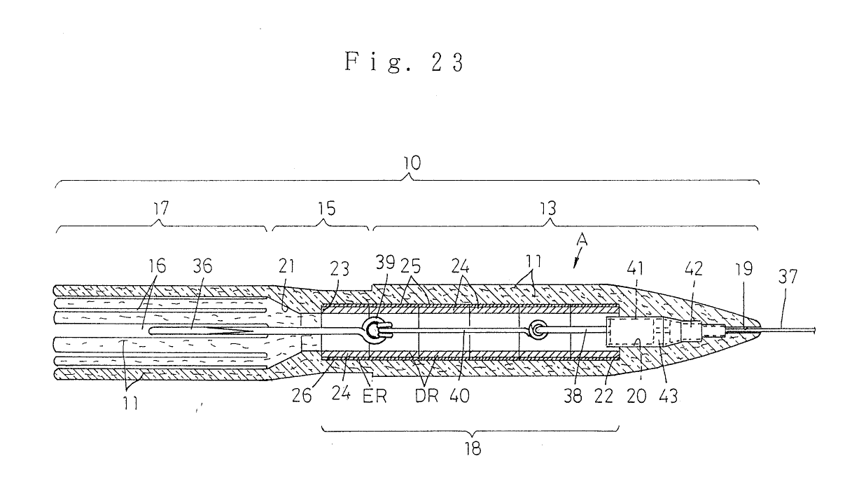

In any case, the squid-shaped-soft lure (A) is provided with the void space (C) which is open along the longitudinal center line (O-O) thereof. Thus, as apparent from FIG. 20 to FIG. 24, a line (37) to a rear end of which a hook (36) is tied in advance can be inserted from the wind cone-like leg part (17) to the leading end (the front end) of the trunk part (13) at which the pair of symmetrical fins (12) project, and guided through the narrow line insertion hole (19) of the trunk part (13) at the front of the lure.

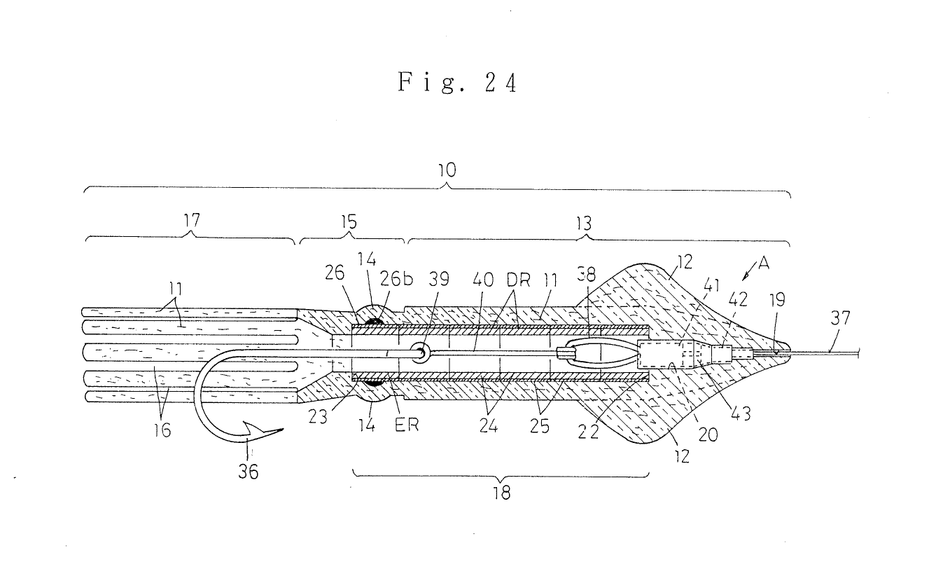

In this case, the rear end of the line (37) is coupled, through a connection ring (38) crimped and fixed in a folded manner as shown in FIG. 23 and FIG. 24, to an attachment ring (39) formed at a base (front end) of the hook (36) via a flexible band made of high-strength polyester fiber etc., (preferably Dyneema (trade name)). Therefore, the coupling band (40) is adjusted to always set a length of the sharp leading end of the hook (36) protruding and exposed partially outside the soft lure (A) to an appropriately fixed position.

Further, the connection ring (rear end) (38) of the line (37) inserted and guided into the void space (C) of the soft lure (A), the attachment ring (base) (39) of the hook (36) and the coupling band (40) of both the rings (38), (39) are surrounded by the colored rings (DR) and the eyeball retaining ring (ER). Since they are not directly in contact with the lure main body (10), there is no risk that the flexible lure main body (10) is damaged at an early stage.

Still further, the hollow lure main body (10) of the soft lure (A) is composed of a thermoplastic elastomer having rubber-like elasticity. The plurality of colored rings (DR) and one eyeball retaining ring (ER), each of which is a segment with a round cross section of the soft synthetic resin hose (24), are integrally press-fitted into the ring receiving hole (18) of the void space (C) in such a manner that they are communicatively connected in a concentric fashion and serially arranged on the longitudinal center line (O-O) of the lure main body (10). Therefore, the lure main body (10) shell is reinforced from the hollow interior by using the soft synthetic resin hose (24) which acts as a core pipe relatively harder than the lure main body (10). Thus, the lure main body (10) is provided with durability so that it will not get out of shape.

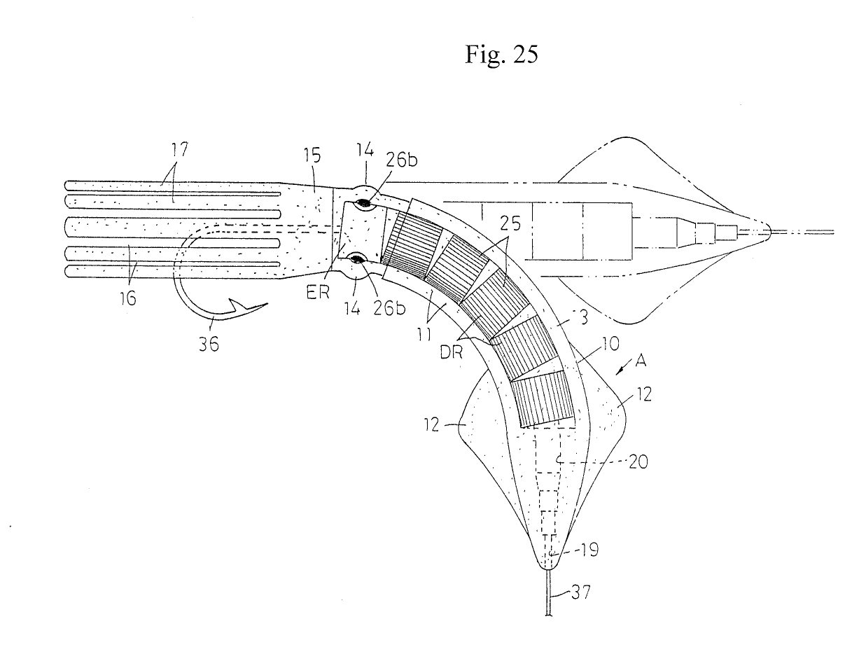

Nevertheless, because the colored rings (DR) and the eyeball retaining rung (ER) are discrete segments as indicated in FIG. 25, the lure main body (10) which internally contains these rings is able to freely bend in all directions without any difficulty, thereby giving impressions of irregular movement of a live squid to fish to be caught and contributing to improvement of fish gathering effects thereof.

Moreover, there is obtained the soft lure (A) excellent in transparency and freshness. Hologram of the colored ring (DR) visible through the lure main body (10) works together with shimmer which results from reflection of light from the shimmering substances incorporated into the lure main body, thus making it possible to give vivid impressions of the body surface of a live squid and greatly improve fish gathering effects of fish to be caught. The soft lure (A) is increased in transparency and freshness to a greater extent when immersed in water.

A reference numeral (41) indicates a rivet crimped by folding the connection ring (38) of the line (37) and fixed, a reference numeral (42) indicates a weight such as lead which is inserted into the line (37) closer to the leading end (front side) thereof than the rivet (41) and fixed or crimped and fixed. As shown in FIG. 23 and FIG. 24, the weight (42) and the rivet (41) are covered with a cover tube (4 3) such as of a soft polyvinyl chloride resin. However, where the soft lure (A) is not submerged into water upon use thereof, the weight (42) may not be attached.

When the soft lure (A) is suspended from the line (37) or the line (37) is pulled from the front, the cover tube (43) for the line abuts against the annulus at the interior end of the line insertion hole (19) and is confined by the cover-tube receiving hole (20) of the trunk part (13) of the lure. The soft lure (A) is able to rotate freely 360 degrees about the line (37) tied with the hook (36).

The squid-shaped soft lure (A) of the present invention is arranged as described above based on this embodiment. Therefore, the squid-shaped soft lure (A) can be used not only by fishermen on a fishing boat for trolling large-size migrant fish but also for special trolling in what is called sport fishing for leisure which uses a pleasure boat (cruiser), thereby offering excellent fishing results for recreational anglers.

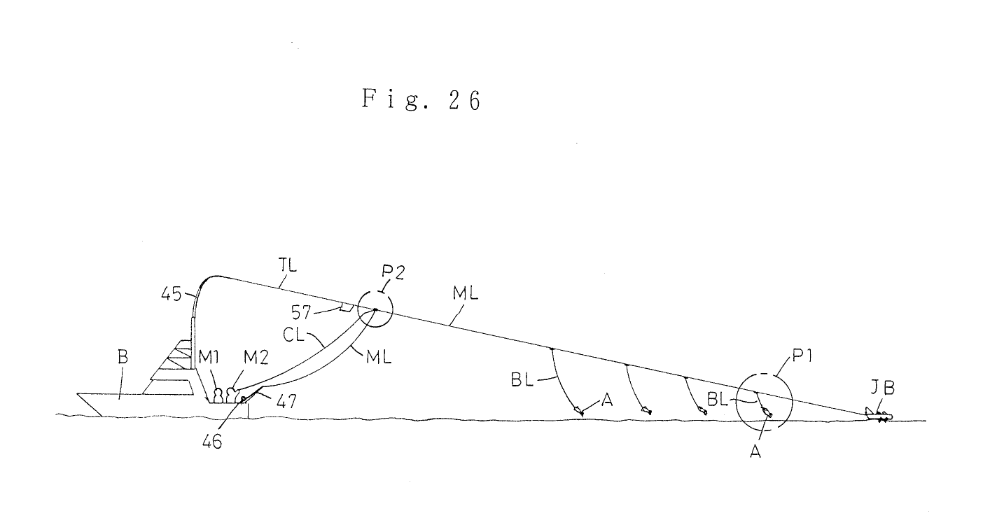

FIG. 26 to FIG. 30 shows an example of use of the present invention. When the squid-shaped soft lure (A) is used, for example, to conduct special trolling (sport fishing) for fish to be caught, such as tuna, one or more of the line (37) equipped with the hook (36) and strung through the lure via the head part (15) and the trunk part (13) from the open leg part (17) of the lure main body (10) and also through the narrow line insertion hole (19) of the trunk part (13), is detachably connected to a main line (ML) as an appropriately long branch line (BL) by a snap opening/closing lock fitting (44) attached to the back (trailing) end of the line (37).

A highly elastic stick (45) (telescopic type rod comprised of 5 stick sections made of fiber reinforced plastic (FRP) and capable of extending up to about 12 meters is attached and fixed to a cockpit deck, a flying deck or at any other appropriate height on a vessel body (B) of a pleasure boat (cruiser) by being set to be about 7.35 meters in height (3-connected rod), for example. A receiver (48) of a boat rod (47) with a reel (46) attached is also attached and fixed at an appropriate position of the vessel body (B) near an angler (M1).

Next, a relatively short and fixed length (for example, about 8 meters) tag line (TL), which is finally to sag down after a fish has been caught, and the main line (ML) which is much longer and appropriately long (for example, about 100 meters) extend away from an upper end (stick tip) of the stick (45) away from the stern of the boat (backward), and a resistance board (Jumbo Bird) (JB) is attached to the leading end (rear end) of the main line (ML).

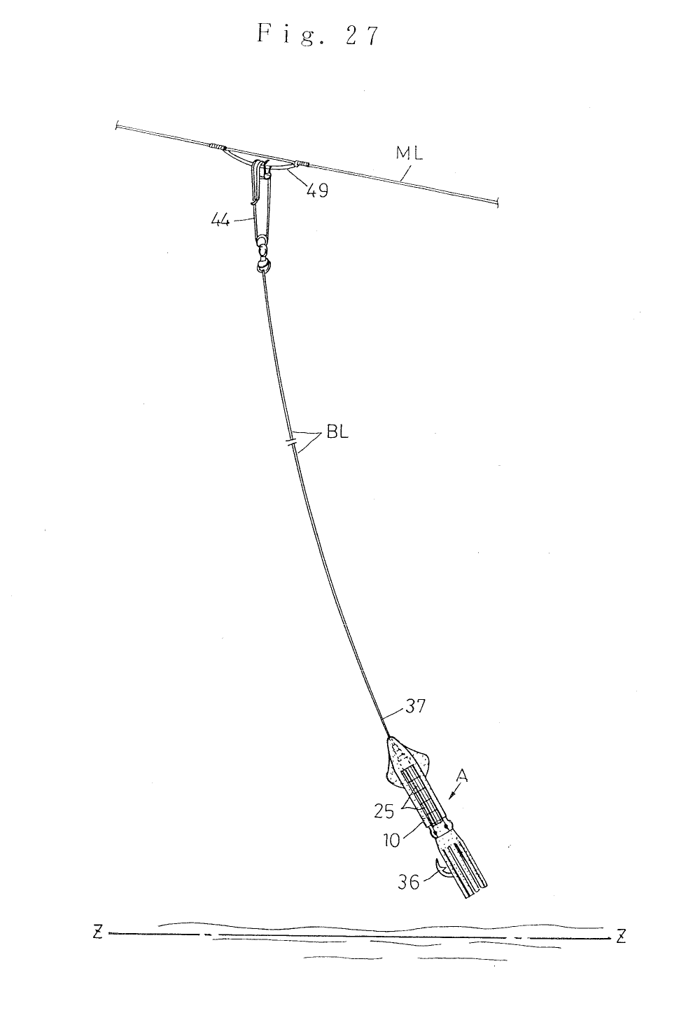

Further, on its way to the main line (ML), a plurality of branch-line locking rings (49) (a total of 4 rings in this embodiment) are installed at appropriately relative intervals (for example, 10 meters) in the back and forth direction. The snap opening/closing lock fitting (44) of the branch line (BL) is locked into each of the branch-line locking rings (49) in a detachable manner as shown in the enlarged view of FIG. 27. Thereby, the soft lure (A) is kept connected so as to be suspended downward from the main line (ML).

In this case, as confirmed in the overall figure of FIG. 26, an action distance of the branch line (BL) which suspends the soft lure (A) downward from the main line (ML) is relatively changed in length by decreasing, for example, from about 3.5 meters-6.5 meters; about 3 meters-5 meters; about 2.5 meters-4.0 meters; to about 2.0 meters-2.5 meters sequentially in a stepwise manner, depending on in what is called a backward-decreasing inclination angle of the main line (ML) extending from the upper end (stick tip) of the stick (45) away from the stern of the boat (backward). Thereby, all the plurality of soft lures (A) (a total of 4 lures in this embodiment) are adjusted for their positions and set so as to be equal, in height to the surface of water (Z-Z) on average or slightly higher so that the lures will float on the surface of water (Z-Z) to some extent and be kept in a state that the lures do not sink into the sea.

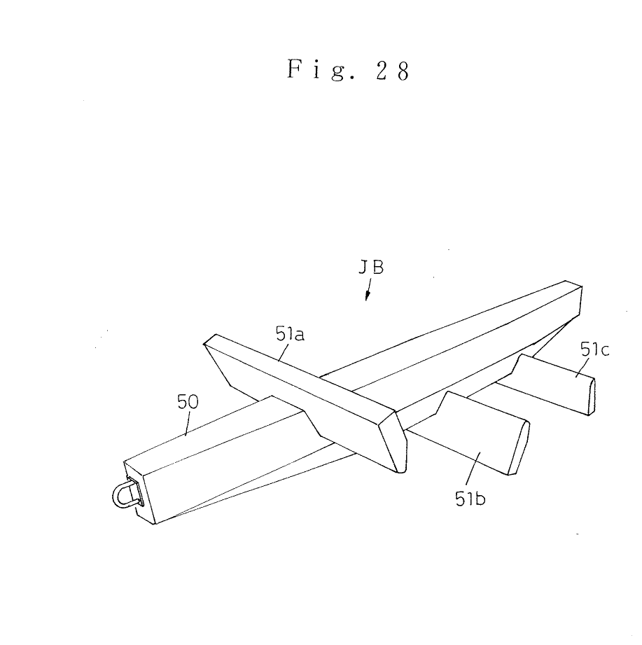

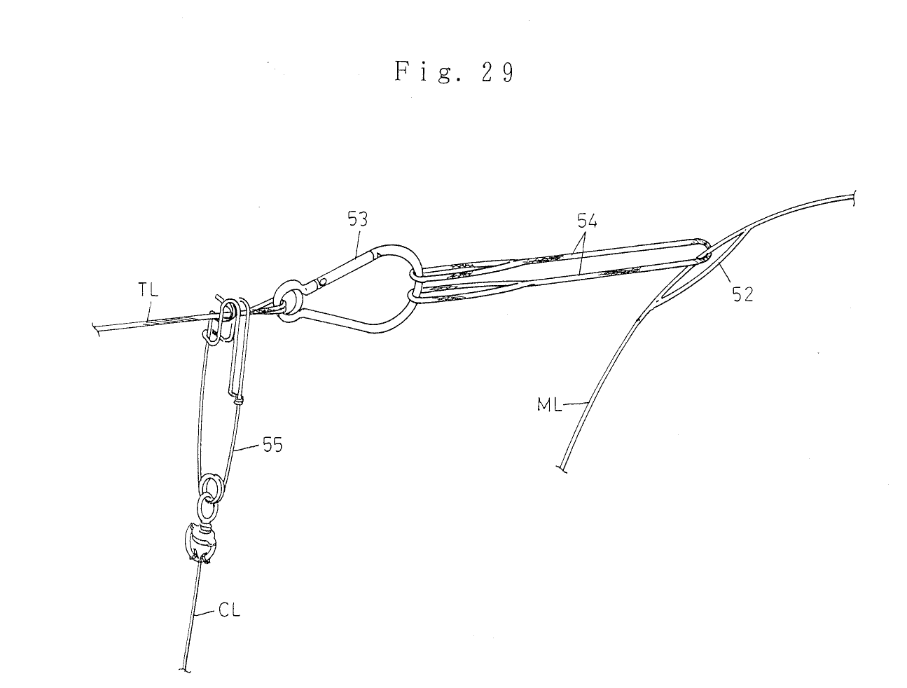

The resistance board (Jumbo Bird) (JE) is made of fiber reinforced plastic (FRP) or polypropylene and assembled in such a manner that, as shown in FIG. 28, a trunk body (50) extending of a predetermined length (for example, about 1,000 mm) in the back and forth direction is orthogonal to a plurality (for example, 3) of wing boards (51a), (51b), (51c) arranged horizontally and of a predetermined length (for example, about 300 mm) in the lateral direction. The Jumbo Bird (JB) is not only effective in tightening straight the tag line (TL) and the main line (ML) from the stick (45) by tensile resistance, to which its weight (for example, about 10 Kg) contributes, but also is effective in gathering fish by creating actions and sounds of vigorously splashing sea water by the wing boards (51a), (51b), (51c) and creating for a tuna a sense of a school of live bait (squid) to be taken by the tuna. The Jumbo Bird (JB) is not a submerged board which is dragged in water but rides on the surface of the water.

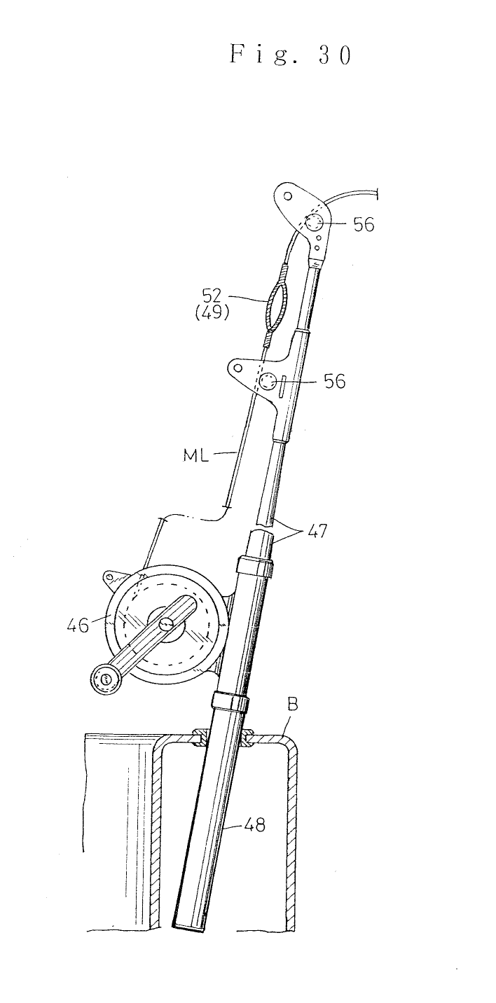

The base (reel end) of the main line (ML) is kept wound around the reel (46) attached to the boat rod (47) and the main line is arranged to be carried away from the reel. A breaker locking ring (52) provided on the main line (ML) is coupled, via a breaker (54), in a detachable manner to a snap opening/closing hook (53) tied at the leading end of the tag line (TL). The breaker (54), shown in FIG. 29, is preferably composed of a braided rope made of a biodegradable resin.

When the main line (ML) is pulled strongly from the leading end thereof due to movement of a tuna which bites the soft lure (A) of the branch line (BL), the breaker (54) breaks and automatically changes from main line (ML) coupled to the tag line (TL) to a main line (ML) which is to be reeled by the reel (46) of the boat rod (47).

Further, a reference symbol (CL) indicates an auxiliary control line (action line) which is connected in a detachable manner near the leading end of the tag line (TL). The lower end of the auxiliary control line (action line) (CL) sagging down from the tag line (TL) to the vessel body (B) is operated by being pulled or released by an assistant (M2) to the angler (M1) on the vessel body (B), thereby giving assistance in manually raising or lowering the soft lure (A). A reference numeral (55) indicates a snap opening/closing lock fitting which is tied at the upper end of the auxiliary control line (action line) (CL) and which is the same as the lock fitting (44) of the branch line (BL).

As shown in FIG. 30, the boat rod (47) equipped with the reel (46) of the main line (ML) is inserted in a detachable manner into the receiver (48) which is fixedly installed on the vessel body (B). A reference numeral (56) indicates each of a plurality of main line guide fittings installed on the boat rod (47), through which the main line (ML) having the branch-line locking ring (49) and the breaker locking ring (52) can be inserted smoothly and easily.

It is preferable that the above described flexible rope made of high-strength polyethylene fiber (trade name “Dyneema”) is adopted as the main line (ML), the tag line (TL) and the auxiliary control line (action line) (CL), while a nylon monofilament is adopted as the branch line (BL).

First, as apparent from numerical values of length and others which are shown as references, the above described trolling is performed in a vast area. It is, therefore, desirable that a flag (57) as a mark for notifying other boats of fishing operation in progress is attached on the tag line (TL) to secure the safety.

After the tag line (TL), the breaker (54), the main line (ML) and the resistance board (JB) are completely aligned straight in sequential order from the stick (45) as described above, the vessel body (B) of the pleasure boat (cruiser) is allowed to run at an appropriate speed (for example, about 5 to 8 knots) to drag the resistance board (JB), whereupon tensile force on the main line (ML) varies due to the influence of wave resistance. This difference is alleviated by force exerted by the elastic stick (45), thereby quickly tightening the main line (ML) which has been loosened.

Further, when the vessel body (B) runs in operation, it bounds, rolls and pitches, and the upper end of the stick (45) sways in lateral and back-and-forth directions. The soft lures (A) are suspended downward in parallel via the plurality of branch lines (BL) from the main line (ML), splashing the surface of the water (Z-Z) and jumping and hopping (floating up and down from the surface of the -water) upon receiving waves or flying over the surface of the water (Z-Z) like flying fish, and these actions are repeated. The bait searching instinct of fish to be caught, such as tuna, is greatly stimulated by these complicated and random actions together with sounds and light in association therewith. The bait searching instinct of tuna is also strongly stimulated by sea water vigorously splashed during dragging of the resistance board (JB) and sounds associated therewith. These actions contribute to fish gathering effects.

Further, the hollow lure main body (10) of the soft lure (A) is made of a transparent or translucent thermoplastic elastomer, and the colored ring (DR) integrally press-fitted into the void space (C) thereof are composed of the soft synthetic resin hose (24) which is relatively harder than the thermoplastic elastomer and the hologram sheet (25) which is wound around the surface (outer circumferential face) of the hose. Therefore, due to light reflecting actions of the reflection layer (25e) as with those of color given to the colored layer (25f) with which the hologram sheet (25) is formed, together with shimmering substances (11) which are incorporated into the lure main body (10), color spots, patchy patterns and shimmering luster on the body surface which closely resemble a live squid are visible from outside the lure main body (10), thereby giving impressions of remarkable transparency and freshness.

Still further, the above described lure main body (10) is a hollow product which is integrally formed with a thermoplastic elastomer high in rubber-like elasticity and strechability. The plurality of colored rings (DR) and one eyeball retaining ring (ER) are internally placed at the ring receiving hole (18) of the void space (C) in such a manner that they are communicatively connected in a concentric fashion and serially arranged as segment of round cross section. Therefore, these rings allow the lure to simulate the movement of a live squid which by imparting to the lure bendability and deformability completely around its circumference at 360 degrees in all directions. In combination with photo-luminescence imparted by the hologram of the hologram sheet (25), it is possible to provide excellent fish gathering effects of fish to be caught.

In this case, the auxiliary control line (action line (CL), sagging down from the tag line (TL) to the vessel body (E) is operated by being pulled or released by the assistant (M2) to the angler (M1) or others, thus making it possible to control manually movement of the soft lure (A) by actively raising or lowering the soft lure (A).

The soft lure (A) is suspended downward from the main line (ML) via the branch line (BL) at a height substantially equal to the surface of the water (Z-Z) on average or floating on the surface of the water (S-Z) to some extent. Thus, tuna which is a large-size migrant fish will gather around the surface of the water (surface layer) (Z-Z) upon perceiving the above fish gathering actions, jumping out. from the water (below) and biting in particular the leg part (17) of the soft lure (A). In some cases, the entire lure (A) is swallowed by the tuna.

At this time, the above described elastic stick (45) is bent and deformed rapidly like a bow from the upper end (stick tip) and also undergoes restorative deformation depending on loads thereof. Thus, there is no risk that the stick gives a strong shock to the tuna, and a temporal difference caused in association with the elastic deformation prevents the tuna from escaping from the hook or the hook cutting its mouth.

In addition, the lure main body (10) of the soft lure (A) is made of a soft thermoplastic elastomer which is high in rubber-like elasticity and strechability. The colored rings (DR) and the eyeball retaining ring (ER) which have, been integrally press-fitted into the hollow interior enable bending and deformation of the lure freely at any point around its circumference (360 degrees). There, is no risk that the soft lure (A) will be perceived by a tuna as being different from a fresh squid. The soft lure (A) is effective in preventing the tuna from escaping from the hook. Further, since the hook (36) is provided at the leg part (17) of the lure main body (10), it is possible to reliably hold the tuna with the hook (36) in combination with the restoration and repulsion of the stick (45).

Next, the tuna which has been held by the hook (36) of the soft lure (A) is to pull the line (branch line) (37). Thereby, the leg part (17) of the lure (A) is bitten off by the tuna to leave the trunk part (13) or the soft lure (A) is not bitten off but left in its entirety. In either case, the lure (A) moves relative to the branch line (37) along the branch line (37) toward the main line (ML), as if being drawn away from the hook (36). It is, thus, possible to reduce resistance of the lure (A) against the tuna and damage to the lure (A) as much as possible.

Further, upon receiving strong pulling strength of the tuna which has bitten the soft lure (A), the breaker (54) coupled with the stick (45) on its way to the main line (ML) breaks automatically, whereupon the tag line (TL) sags down from the upper end of the stick (45), leaving the main line (ML) connected and continuing only to the reel (46) of the beat rod (47). Thereupon, an angler (M1) rotation-ally operates the reel (46) of the main line (ML) so that the tuna is pulled close to the vessel body (B) and brought inside the vessel body (B) by using a gaff or the like. In this case, regarding the line (branch line) (37) of the lure (A) at which no tuna, has bitten, it is acceptable that the lock fitting (44) is removed from the main line (ML).

In trolling as sport fishing in which the use of the present invention is described based on FIG. 26 to FIG. 30, the squid-shaped soft lure (A) splashes the surface (surface layer) of the water (Z-Z) or jumps out from the surface of the water (Z-Z) with actions of the elastic stick (45) and the resistance board (JB), and repeats complicated and random movement of live bait (squid) such as escaping in combination with sounds and shimmering shimmer (luster) in association with the movement. Thereby, it is possible to stimulate greatly the bait searching instinct of the fish to be caught (tuna) and also obtain fish gathering effects similar to those of live bait (real squid) and excellent fishing results.

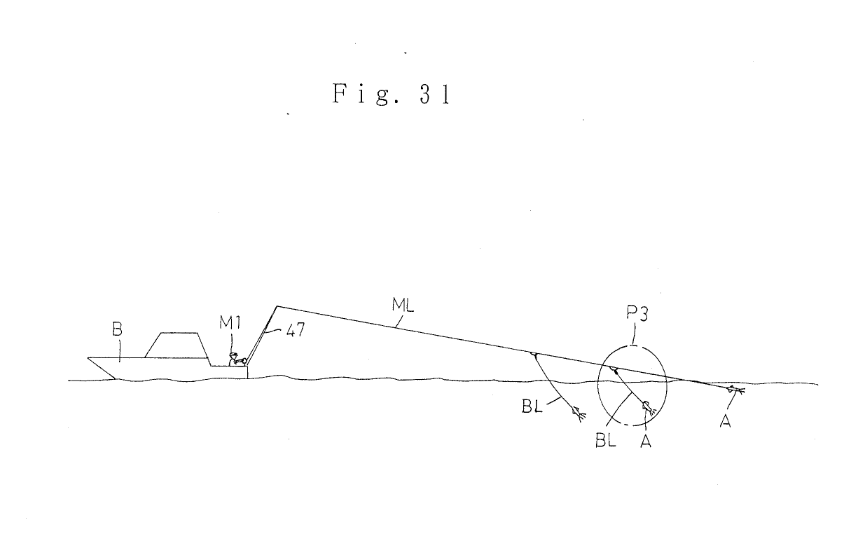

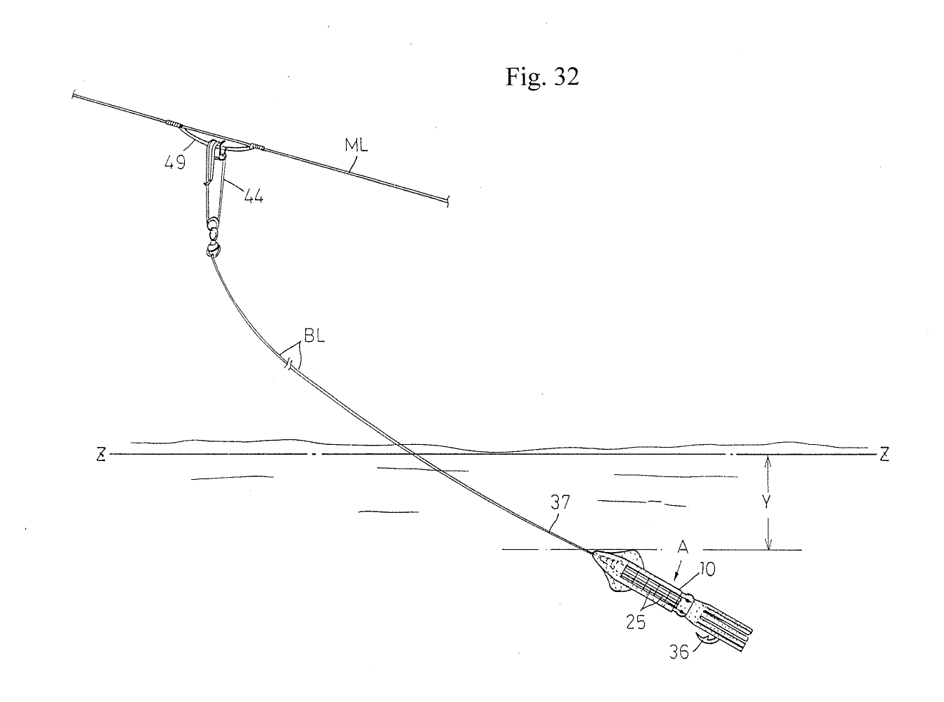

As a matter of course, the soft lure (A) of the present invention is applicable to special trolling which uses the above described stick (45). As apparent from modified use examples shown in FIG. 31 and FIG. 32 corresponding to FIG. 26, the soft lure (A) of the present invention is also applicable in such a case that in place of installation of the stick (45), the soft lures (A) are connected individually to the leading end of the main line (ML) carried away from the reel (46) of the boat rod (47) and also to the lower end of each of the branch lines (BL) branched from the main line (ML), and the soft lures (A) are kept sunk only by an appropriate depth (Y) from the surface of the water (Z-Z) by adjusting the weight (42) attached thereto and by using a submerged board (not. illustrated) and dragged by using the vessel body (B).

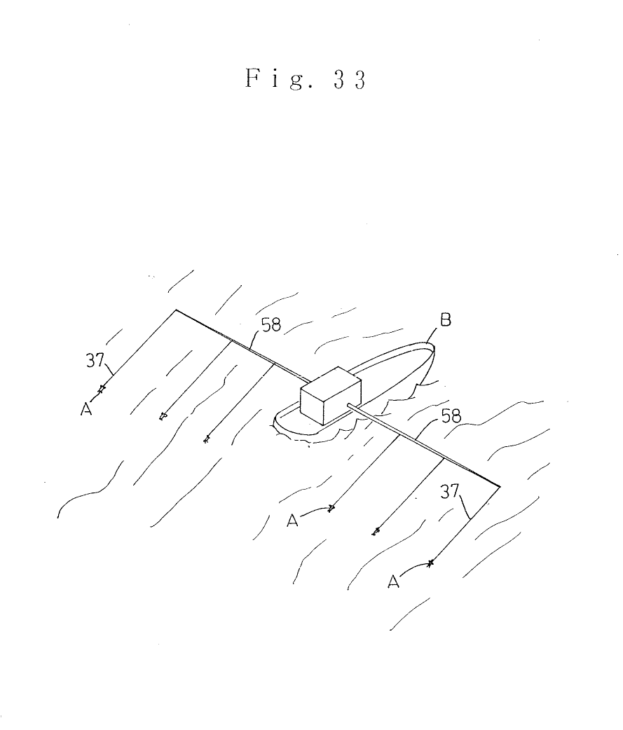

Further, as apparent from FIG. 33 which shows conventional trolling, respective fishing poles (53) are brought out horizontally in the lateral direction from the vessel body (B) and the soft lures (A) suspended downward therefrom via the lines (37) corresponding to the main line (ML) or the branch line (BL) are also kept sunk into the water only by an appropriate depth (Y), by which the soft lure (A) can be dragged by the vessel body (B).

Further, the squid-shaped soft lure (A) of the present invention is conveniently applicable to long-line fishing in which the soft lure (A) shown in FIG. 5 of Japanese Published Unexamined Patent Application No. 2009-278953 is kept sunk into the water by using a weight (42) or the like, although not presently illustrated, and also to single rod fishing by using the boat rod (47) from the vessel body.

A description has been given of a case that tuna is a typical fish to be caught. As a matter of course, the present invention is widely applicable to other fishing for smaller size fish than tuna such as Japanese amberjack, bonito and young yellow tail.

As described so far, in the squid-shaped soft lure (A) of the present invention, the lure main body (10) is integrally formed in a hollow squid shape with a transparent or translucent thermoplastic elastomer into which shimmering substances (11) are incorporated, the plurality of colored rings (DR), each of which is cut so as to give a segment with a round cross section which is composed of the soft synthetic resin hose (24) and the hologram sheet (25) adhered to the surface (outer circumferential face) of the hose, are integrally press-fitted into the trunk part (13) of the lure main body (10) in such a manner that they are serially arranged. Therefore, the squid-shaped soft lure (A) is extremely excellent in transparency and freshness, and in combination with the reflection of light which has passed through the lure main body (10), hologram of the hologram sheet (25) and shimmering substances (11), the lure main body (10) is able to give impressions of color tone (coloring/pattern) and shimmer (luster) which closely resemble the body surface of a live squid (real squid) to fish to be caught, thereby improving fish gathering effects of the fish to be caught.

Further, the thermoplastic elastomer which is a material of the lure main body (10) is high in rubber-like elasticity and stretchability. The plurality of colored rings (DR) and one eyeball retaining ring (ER) which have been integrally press-fitted into the hollow interior of the lure main body (10) are composed of segments with a round cross section of the soft synthetic resin hose (24) and formed in such a manner that they are communicatively connected in a concentric fashion and serially arranged as a whole. Therefore, these rings are able to freely bend and deform at all points of the 360 degree circumference of the lure in all directions and are also able to give realistic impressions of swimming movement of a live squid (real squid). In this respect as well, the soft lure (A) of the present invention can be used to provide excellent fishing results achieved by professional fishermen.

While the thermoplastic elastomer of the lure main body (10) is flexible, the colored rings (DR) and the eyeball retaining ring (ER), each of which is cut so as to give a segment with a round cross section of the soft synthetic resin hose (24) relatively harder than the lure main body, are integrally press-fitted into the hollow interior, to constitute what may be called a reinforced core pipe. Therefore, while the lure main body (10) is able to bend and deform freely as described above, it is possible to prevent in advance the lure main body (10) from getting out of shape or being torn apart and, the lure main body (10) can be made substantially durable.

The plurality of colored rings (DR) and one eyeball retaining ring (ER) can be integrally press-fitted into the ring receiving hole (18) of the lure main body (10) easily and smoothly from the trumpet-shaped round rod jig receiving guide hole (21) of adjacent the leg part (17) by using the round rod jig (J). The colored rings (DR) and the eyeball retaining ring (ER) which are serially arranged as a whole as well as the cover tube (43) which is to be inserted into the line cover tube receiving hole (20) are used to effectively and reliably prevent such a risk that the lure main body (10) made of the thermoplastic elastomer be damaged at. an early stage by direct contact with the line (37) and the coupling band (40) for coupling the line (37) with the hook (36).

The eyeball retaining ring (ER) of the head part (15) is positioned so as to correspond to and align with the eyeball covering faces (14) of the lure main body (10) made of a transparent or translucent thermoplastic elastomer. Therefore, it is possible to closely make resemble an external appearance of the squid-shaped soft lure (A) to that of live bait (real squid). In combination with the above described color tone (coloring/pattern), shimmer (luster) and movement, the squid-shaped soft lure (A) further improves fish gathering effects of fish to be caught.

According to the manufacturing method of the invention, the plurality of colored rings (DR) and one eyeball retaining ring (ER), each of which a segment with a round cross section, can be press-fitted reliably and efficiently into the hollow interior from the wind cone-like leg part (17) of the lure main body (10) by using a single round rod jig (J) on which all these rings are mounted. The rings will be elastically attached to the lure main body (10) in a firmly integral manner without using a special adhesive agent. As a result, it is possible to manufacture (assemble) the lure at high efficiency.

Further according to the invention, it is possible to manufacture the plurality of colored rings (DR) and one eyeball retaining ring (ER) quite efficiently. The operation of press-fitting these rings into the hollow interior of the lure main body (10) can be carried out by mounting the colored rings (DR) and the eyeball retaining ring (ER) on the thin shaft part (31) of the round rod jig (J) continuously whereupon the rings are shifted along the thin shaft part (31) of the round rod jig (5), thereby contributing to further improvement in productivity (assembly).

1. A squid-shaped soft lure for fishing comprising:
a squid-shaped lure main body having a hollow interior and comprised of a transparent or translucent thermoplastic elastomer with rubber-like elasticity into which shimmering substances are incorporated, the lure main body including parts shaped as a squid head, a squid trunk and squid legs, and the lure main body having a line insertion opening through the head part and communicating with the hollow interior of the lure so that a line with a hook at a leading end thereof can sequentially run through the leg part, trunk part and head part;
a plurality of colored rings, each of which is comprised of a segment of a transparent or translucent soft synthetic resin hose having an outer circumferential face which is covered by a hologram sheet; and
one eyeball retaining ring which is comprised of a segment of transparent or translucent soft synthetic resin hose having an outer circumferential face to which is adhered a pair of symmetrical eyeball sheets, wherein
the plurality of colored rings and one eyeball retaining ring are integrally press-fitted into, respectively, the squid shape trunk part of the lure main body and the head part thereof in such a manner that the rings are communicatively connected in a concentric fashion and serially arranged as a whole.

2. The squid-shaped soft lure for fishing according to claim 1, wherein
squid-like fins protrude from the trunk part of the lure main body,
the hollow interior of the lure main body comprises a ring receiving hole of uniform inner diameter, concentric with a center line of the lure main body and extending from a substantially middle point position between the fins to a position corresponding to a middle point of the head part,
the plurality of colored rings and the one eyeball retaining ring are integrally press-fitted into the ring receiving hole with the colored rings press-fitted in the trunk part of the ring receiving hole and the eyeball retaining ring press-fitted in the head part of the ring receiving hole with all the rings being serially arranged as a whole,
a stepwise tapering space between a front end of the ring receiving hole and the line insertion hole, the line insertion hole opening at a leading end of the trunk part, is formed as, in effect, a a stepped tubular hole for receiving and covering the line, and
the leg part is of wind cone-shape and has a plurality of slits, and a space between the rear end of the ring receiving hole and a proximal end of the leg part is formed as a guide hole for receiving a round rod jig, the guide hole expanding toward its proximal end in a trumpet shape.

3. The squid-shaped soft lure for fishing according to claim 2, wherein
two areas of a surface of the head part of the lure main body corresponding to a position where the eyeball retaining ring is integrally press-fitted are formed each in a circular-arc convex shape as a pair of symmetrical eyeball covering faces.

4. A method for manufacturing a squid-shaped soft lure for fishing of claim 1, comprising
integrally forming a lure main body is into a hollow squid shape having a hollow interior and comprised of a transparent or translucent thermoplastic elastomer with rubber-like elasticity into which shimmering substances are incorporated, and
mounting in serial arrangement on one round rod jig in common, a plurality of colored rings, each of which is composed comprised of a soft synthetic resin hose divided into segments with a round cross section and a hologram sheet winch is integrally wound around a circumferential surface of the hose and one eyeball retaining ring which is comprised of a transparent or translucent soft synthetic resin hose and a pair of symmetrical eyeball sheets adhered to a circumferential surface of the hose and, with all the rings thus mounted, press fitting the rings into the hollow interior from a leg part of the lure main body, and
pulling out the round rod jig from the lure main body, all the rings remaining firmly attached in an integral manner to the hollow interior by a restorative shrinkage force resulting from expansion, and deformation of the lure main body.

5. The method for manufacturing a squid-shaped soft lure for fishing according to claim 4, wherein
one common transparent or translucent soft synthetic resin hose from which the plurality of colored rings and the one eyeball retaining ring are to be produced is mounted in a detachable manner on a thin shaft part of the round rod jig from a leading end of the thin shaft part and, with the hose thus mounted,
a proximal part of the hose of predetermined length is reserved as a space for adhering eyeball sheets for the eyeball retaining ring, and the hologram sheet for the colored rings is wound around on an entire surface of a remaining length of the hose in an integrated manner,
thereafter, while rotating the round rod jig and therewith the hose mounted thereon, cutting the hose, by using a cutter, into the plurality of colored rings wrapped with the hologram sheet and a ring reserved for adhering thereto of eyeball sheets, each of the rings being a segment of the hose with a round cross section, and
completing producing the eyeball retaining ring by adhering to a circumferential surface of the reserved ring a pair of symmetrical eyeball sheets.

6 The method for manufacturing a squid-shaped soft lure for fishing according to claim 5, wherein
the cutting of the hose is at equal intervals along the length of the hose whereby all the rings are equal in length.
